(19) United States
(12) Patent Application Publication
(10) Pub. No.: US 2026/0262579 A1
(43) Pub. Date: Sep. 10, 2026

(54) Panel and Multilayer Panel Structure

(71) Applicant: Jee Keng LIM, Singapore (SG)

(72) Inventor: Jee Keng LIM, Singapore (SG)

(21) Appl. No.: 19/164,097

(22) PCT Filed: Mar. 8, 2024
(86) PCT No.: PCT/SG2024/050142

§ 371 Date: Sep. 10, 2025

(30) Foreign Application Priority Data
Mar. 10, 2023 (SG) 10202300650T

(51) Int. Cl. A01G 13/27; B65D 19/40; E01C 5/00; E03F 1/00

(52) U.S. Cl. CPC A01G 13/27; B65D 19/40; E01C 5/001; E03F 1/00

(57) ABSTRACT

A panel is provided. The panel includes a main body including a top surface, a bottom surface opposite the top surface, such that the top surface includes a top perimeter edge and the bottom surface includes a bottom perimeter edge, a boundary wall extending from the top perimeter edge to the bottom perimeter edge, a plurality of interlocking members formed along the boundary wall adapted to engage the corresponding plurality of interlocking members of another panel, at least one connecting portion disposed adjacent the boundary wall and on the top surface and adapted to connect a support column for supporting the main body and the support column includes a connecting end connectable to the main body, such that the at least one connecting portion is configured to include, a first alignment pattern adapted to align the connecting end to connect to the at least one connecting portion within the boundary wall when connected, and a second alignment pattern adapted to align the connecting end to connect a portion of the connecting end to the at least one connecting portion, such that the connecting end protrudes out of the boundary wall when connected, such that the first alignment pattern intersects with the second alignment pattern, and such that the second alignment pattern of the panel when aligned to the second alignment pattern of the another panel, forms the first alignment pattern to align the connecting end to connect to the panel and the another panel. In addition, a multilayer panel structure is provided.

### FIELD OF THE INVENTION

This invention relates to an interlockable panel adapted for use to engage with other panels to form a multilayer panel structure to be installed underground for promoting tree root growth, managing stormwater runoff, and supporting hardscape/softscape areas, or to form a double-slab formwork, a raised stage, or a pallet for storing and transporting goods.

### BACKGROUND OF THE INVENTION

In landscaping and gardening activities, hardscape (e.g. walkways, driveways, concrete patios, water features, parking areas, etc.) and softscape (e.g. trees, flowers, grasses, vegetation, etc.) are often used to make our environment more aesthetically pleasing and healthy living. However, in order to keep the hardscape/softscape in place and to prevent any damage to them due to poor soil structure, a strong support system that acts as a stable base with a high loading capacity to support the hardscape/softscape above is desired.

Growing big healthy trees in urban areas is increasingly difficult due to lack of open space. Hence, in urban areas, trees are commonly planted next to the sidewalk/roadway or within small openings in the sidewalk/roadway. As trees grow, tree roots would grow and extend against the sidewalk/roadway which may cause damages to the sidewalk/roadway. Furthermore, a firm and compacted soil is required to support the heavy sidewalk/roadway which will impede the growth of the tree roots. Hence, in order to resolve the above issues, a tree root protection system that enables tree roots to grow freely and healthily with sufficient oxygen and moisture is desired.

Controlling and managing stormwater runoff is another problem in urban areas. A good stormwater management system would be able to collect excessive runoff water, filter the runoff water by removing trashes and big particles, and slowly discharge the runoff water to public drains. Due to high cost and space constraints, a conventional concrete stormwater treatment facility is not a good option. Hence, a cost effective and easy to implement stormwater management system that can be installed in urban and flood-prone areas or underneath hardscape/softscape is highly desired.

In view of the above, there exits the need for a scalable, efficient, cost effective, and easy to implement system that can accommodate all the requirements for a strong base support, tree root protection, and stormwater runoff management.

### SUMMARY OF THE INVENTION

The above and other problems are solved and an advance in the art is made by provision of an interlockable panel which can be used to form a scalable multilayer panel structure for supporting hardscape/softscape areas, promoting tree root growth, and managing stormwater runoff, or to form a double-slab formwork, a raised stage, or a logistic pallet for storing and transporting goods.

Due to its functional design and material used, the panel of this invention has many advantages including the following aspects. The panel is environmentally friendly, lightweight, strong, durable, reusable, cost effective, high loading capacity, and easy to install. A multilayer panel structure formed by the panels with vertical support columns can be used to accommodate all the requirements for supporting hardscape/softscape areas, promoting healthy tree root growth, and managing stormwater runoff in urban areas. Importantly, the multilayer panel structure able to provide multiple connection options with the support columns thereby allowing to reduce the number of support columns to be used, and thus reducing the material cost and installation cost of the multilayer panel structure significantly. Due to the modular feature and efficient interlocking mechanism of the panel, the multilayer panel structure is scalable to any size and can be installed/disassembled easily without any additional attachments or tools. Furthermore, a simple logistic pallet can be formed by two (or more) interlocked panels attached with suitable support legs for storing goods and movable by forklift.

According to various embodiments, a panel is provided. The panel includes a main body including a top surface, a bottom surface opposite the top surface, such that the top surface includes a top perimeter edge and the bottom surface includes a bottom perimeter edge, a boundary wall extending from the top perimeter edge to the bottom perimeter edge, a plurality of interlocking members formed along the boundary wall adapted to engage the corresponding plurality of interlocking members of another panel, at least one connecting portion disposed adjacent the boundary wall and on the top surface and adapted to connect a support column for supporting the main body and the support column includes a connecting end connectable to the main body, such that the at least one connecting portion is configured to include, a first alignment pattern adapted to align the connecting end to connect to the at least one connecting portion within the boundary wall when connected, and a second alignment pattern adapted to align the connecting end to connect a portion of the connecting end to the at least one connecting portion, such that the connecting end protrudes out of the boundary wall when connected, such that the first alignment pattern intersects with the second alignment pattern, and such that the second alignment pattern of the panel when aligned to the second alignment pattern of the another panel, forms the first alignment pattern to align the connecting end to connect to the panel and the another panel.

According to various embodiments, the boundary wall may include a pair of length sides spaced apart from each other and a pair of width sides extended between across the pair of length sides, such that the pair of length sides coincides with the pair of width sides to form four corners, each corner formed by a length side and a width side, such that the main body may include a plurality of connecting portions on the top surface, such that each of the four corners may include a connecting portion.

According to various embodiments, the connecting portion at each of the corners may further include a third alignment pattern adapted to align the connecting end to connect a portion of the connecting end to the connecting portion, such that the connecting end protrudes out of the length side and the width side of one of the corners when connected, such that the third alignment pattern intersects with the first alignment pattern and the second alignment pattern, and such that the third alignment pattern of the panel when aligned to the third alignment patterns of three of the another panels abutting each other at the respective corners form the first alignment pattern to align the connecting end to connect to the panel and the three of the another panels.

According to various embodiments, the main body may further include a connecting portion disposed adjacent each of the length sides of the boundary wall, between the corners along each length side, and on the top surface.

According to various embodiments, the panel may further include another connecting portion disposed adjacent the boundary wall and on the bottom surface of the main body.

According to various embodiments, the panel may further include a plurality of connecting portions disposed at each of the corners and on the bottom surface of the main body.

According to various embodiments, the panel may further include the another connecting portion disposed adjacent each of the length sides of the boundary wall, between the corners along each of the length sides, and on the bottom surface.

According to various embodiments, the panel may further include an another first alignment pattern intersecting at a left side of the first alignment pattern and another first alignment pattern intersecting at a right side of the first alignment pattern, an another second alignment pattern intersecting a left side of the second alignment pattern and an another second alignment pattern intersecting a right side of the second alignment pattern, such that the first alignment pattern and both another first alignment patterns and the second alignment pattern and the another second alignment patterns are lined along the length side of the boundary wall.

According to various embodiments, the connecting portion or another connecting portion may include a plurality of grooves adapted to receive the connecting end therein to connect the support column to the panel, such that the first alignment pattern may include a circular groove and the second alignment pattern may include a semi-circular groove.

According to various embodiments, the third alignment pattern may include a quarter-circular groove.

According to various embodiments, the main body may include an outer body section along the boundary wall and an inner body section within the outer body section, such that the inner body section is detachable from the outer body section.

According to various embodiments, a multilayer panel structure is provided for promoting tree root growth, managing stormwater runoff, or supporting hardscape/softscape area, the multilayer panel structure includes two or more layers of the panels according to any one of the above various embodiments, such that each layer of the panels may include two or more panels interlocked together laterally via the interlocking members, and a plurality of support columns connecting the two adjacent layers of the panels space apart from each other such that each of the support columns includes two connecting ends opposite each other, each connecting end connectable to each of the two adjacent layers of panels.

According to various embodiments, each of the connecting ends of the support column is connectable to the connecting portion and aligned to one of the first alignment pattern on a panel, the second alignment patterns formed by two adjacent panels, and the third alignment patterns formed by four adjacent panels, such that a support column is configured to support one, two or four panels respectively.

According to various embodiments, the panel structure may further include a waterproofing sheet adapted be lined outside the structure to retain water within the structure.

According to various embodiments, the support columns may include a space therein and is adapted to be filled with mortar to enhance the compressive strength of the multilayer panel structure.

### BRIEF DESCRIPTION OF THE DRAWINGS

The above and other features and advantages of this invention are described in the following detailed description of preferred embodiments with reference to the below figures:

FIG. 1 shows a top plan view of a panel in accordance with an exemplary embodiment of the present invention.

FIG. 2 shows a top perspective view of the panel of FIG. 1.

FIG. 3 shows a bottom plan view of the panel of FIG. 1.

FIG. 4 shows a bottom perspective view of the panel of FIG. 1.

FIG. 5 shows a partial enlarge view of the connecting portion around a corner of the panel of FIG. 1.

FIG. 6A shows a partial enlarge view of the connecting portion along a length side of the panel.

FIG. 6B shows a partial enlarge view of another embodiment of the connecting portion along a length side of the panel.

FIG. 7 shows a top plan view of the outer body section of a panel in accordance with an embodiment of this invention.

FIG. 8 shows a top perspective view of the outer body section of FIG. 7.

FIG. 9 shows a perspective view of an inner body section attachable to the outer body section of FIG. 7.

FIG. 10A shows a top plan view of two interlocked panels with the connecting portions as shown in FIG. 6A.

FIG. 10B shows a top view of two interlocked panels with the connecting portions as shown in FIG. 6B.

FIG. 11 shows a top perspective view of two interlocked panels of FIG. 10A.

FIG. 12 shows a top plan view of four interlocked panels of FIG. 1.

FIG. 13 shows a top perspective view of four interlocked panels of FIG. 12.

FIG. 14 shows a partial enlarge view of the connecting portions around the corners of four interlocked panels.

FIG. 15 shows an exemplary embodiment of a multilayer panel structure having three layers of the panels connected by a plurality of support columns.

FIG. 16 shows a perspective view of a support column in accordance with an exemplary embodiment of this invention.

### DETAILED DESCRIPTION OF THE INVENTION

A first aspect of this invention relates to an interlockable panel adapted for use to form a multilayer panel structure to be installed underground for promoting healthy tree root growth, managing stormwater runoff, and supporting hardscape/softscape areas. A second aspect of this invention relates a panel adapted for use to form a pallet (e.g. formed by two interlocked panels with support legs) for storing goods and movable from one location to another by a forklift.

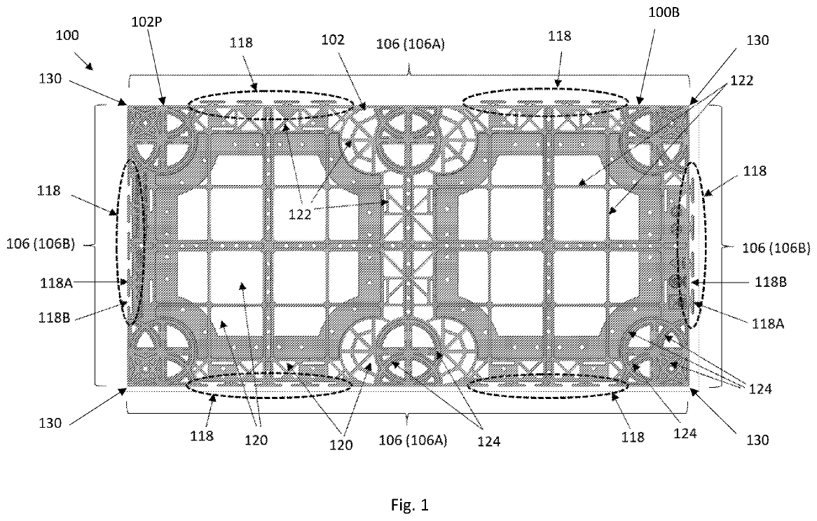

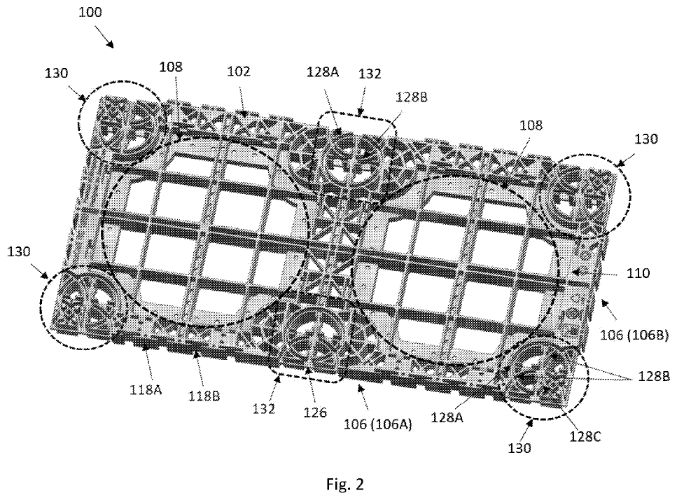

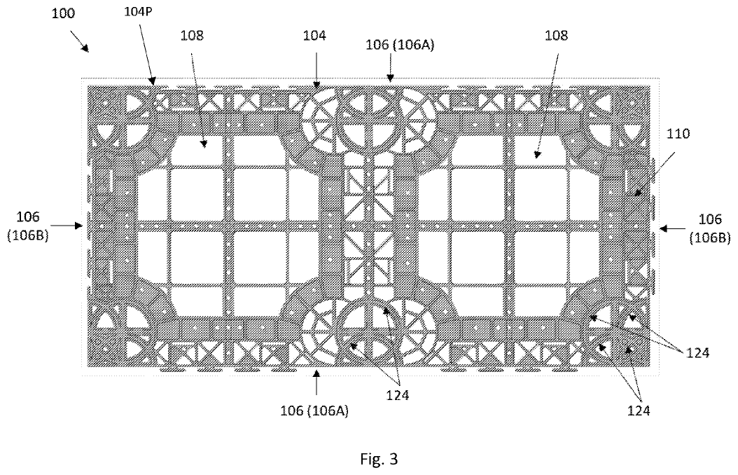

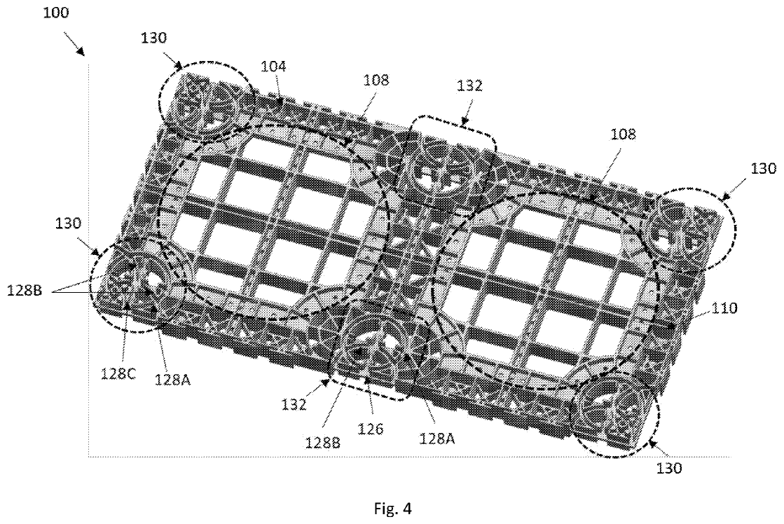

FIG. 1 & FIG. 2 show a top plan view and a top perspective view of a panel 100 in accordance with an exemplary embodiment of the invention. FIG. 3 & FIG. 4 show a bottom plan view and a bottom perspective view of panel 100. Panel 100 is an environmentally friendly product made from waste materials. Panel 100 may be a single piece moulded planar structure made from 100% recycled plastic materials (preferably polypropylene) by an injection moulding machine. Panel 100 is also a sustainable product as at the end of its life cycle, it can be crushed and turned into a useful raw material for making new products, thereby helping to reduce waste and carbon footprint. Due to its functional design and material use, panel 100 is lightweight (e.g. less than 4 kg), has high loading capacity, reusable, strong, sturdy, durable, cost effective, and easy to install/disassemble.

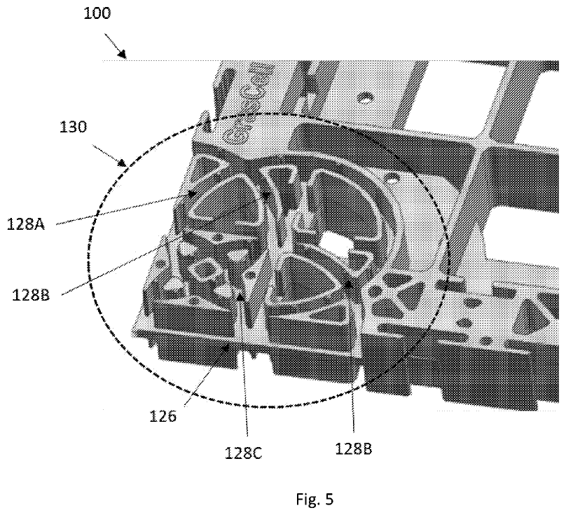

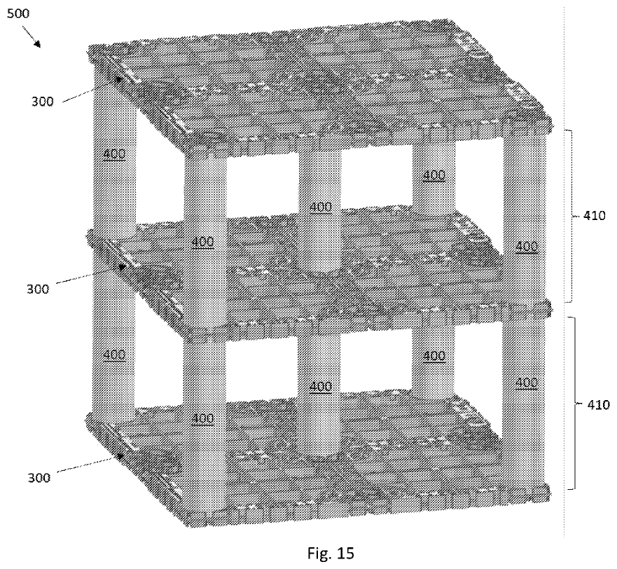

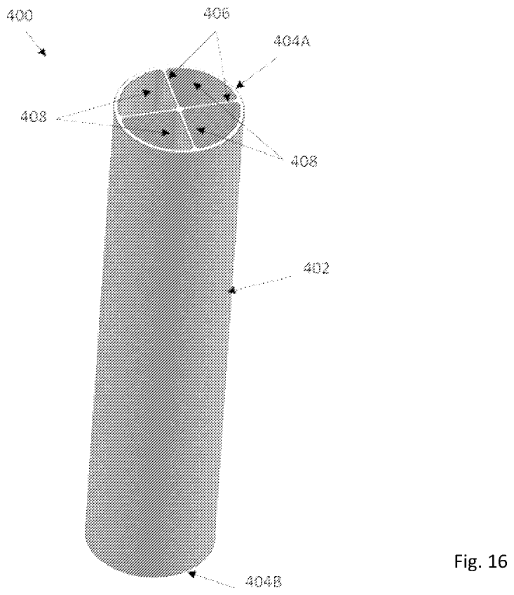

Referring to FIG. 1 and FIG. 2, the panel 100 includes a main body 100B including a top surface 102, a bottom surface 104 opposite the top surface 102, such that the top surface 102 includes a top perimeter edge 102P and the bottom surface 104 (see FIG. 3 and FIG. 4) includes a bottom perimeter edge 104P, a boundary wall 106 extending from the top perimeter edge 102P to the bottom perimeter edge 104P, a plurality of interlocking members 118 formed along the boundary wall 106 adapted to engage the corresponding plurality of interlocking members 118 of another panel 100, at least one connecting portion 124 disposed adjacent the boundary wall 106 and on the top surface 102 and adapted to connect a support column 400 (see FIG. 15) for supporting the main body 100B and the support column 400 includes a connecting end 404A (see FIG. 16) connectable to the main body 100B, such that the at least one connecting portion 124 is configured to include, a first alignment pattern 128A (see FIG. 5) adapted to align the connecting end 404A to connect to the at least one connecting portion 124 within the boundary wall 106 when connected, and a second alignment pattern 128B adapted to align the connecting end 404A to connect a portion of the connecting end 404A to the at least one connecting portion 124, such that the connecting end 404A protrudes out of the boundary wall 106 when connected, such that the first alignment pattern 128A intersects with the second alignment pattern 128B, and such that the second alignment pattern 128B of the panel 100 when aligned to the second alignment pattern 128B of the another panel 100 laterally, forms the first alignment pattern 128A to align the connecting end 404A to connect to the panel 100 and the another panel 100.

Main body 100B is thus be defined by the top surface 102, the bottom surface 104 and the boundary wall 106. Boundary wall 106 may include a pair of length sides 106A spaced apart from each other and a pair of width sides 106B extended between and across the pair of length sides 106A, such that the pair of length sides 106A coincides with the pair of width sides 106B to form four corners 130, i.e. each corner 130 formed by a length side 106A and a width side 106B. A connecting portion 124 at each of the corners 130 may include a third alignment pattern 128C adapted to align the connecting end 404A to connect a portion of the connecting end 404A to the connecting portion 124, such that the connecting end 404A protrudes out of the length side 106A and the width side 106B of one of the corners 130 when connected, such that the third alignment pattern 128C intersects with the first alignment pattern 128A and the second alignment pattern 128B, and such that the third alignment pattern 128C of the panel 100 when aligned to the third alignment patterns 128C of three of the another panels 100 abutting each other at the respective corners 130 form the first alignment pattern 128A to align the connecting end 404A to connect to the panel 100 and the three of the another panels 100. As shown in FIG. 1 and FIG. 2, the main body 100B may include a plurality of connecting portions 124 on the top surface 102, such that each of the four corners 130 may include a connecting portion 124. Main body 100B may include a connecting portion 124 disposed adjacent each of the length sides 106A of the boundary wall 106, between the corners 130 along each length side 106A, and on the top surface 102. Referring to FIG. 3 and FIG. 4, the panel 100 may further include another connecting portion 124 disposed adjacent the boundary wall 106 and on the bottom surface 104 of the main body 100B. Panel 100 may further include a plurality of connecting portions 124 disposed at each of the corners 130 and on the bottom surface 104 of the main body 100B. Panel 100 may further include the another connecting portion 124 disposed adjacent each of the length sides 106A of the boundary wall 106, between the corners 130 along each of the length sides 106A, and on the bottom surface 104. Main body 100B may include an outer body section 110 along the boundary wall 106 and an inner body section 108 within or surrounded by the outer body section 110. Panel 100 may be formed in any suitable shape and size, such as rectangular (length sides 106A>width sides 106B) or square (length sides 106A=width sides 106B). For example, the panel 100 as shown in FIG. 1 has a rectangular shape with dimensions of 1000 mm (length)×500 mm (width)×40 mm (thickness). Alternatively, panel 100 may be formed in a square shape (not shown) with dimensions of 500 mm (length)×500 mm (width)×40 mm (thickness).

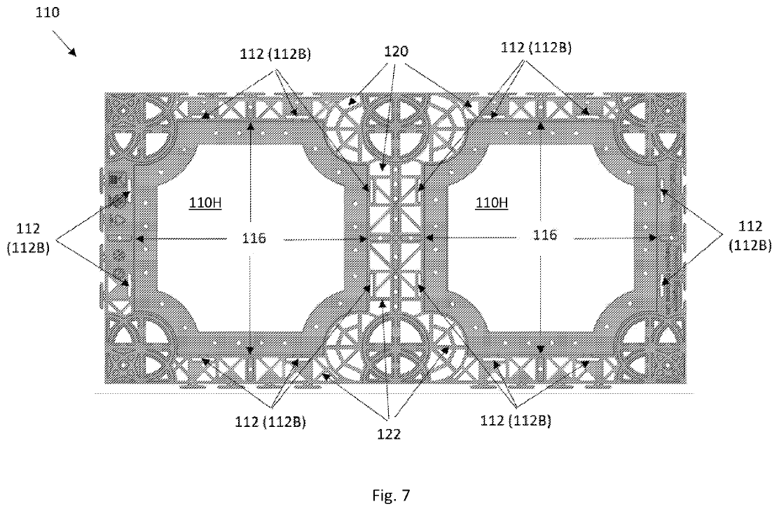

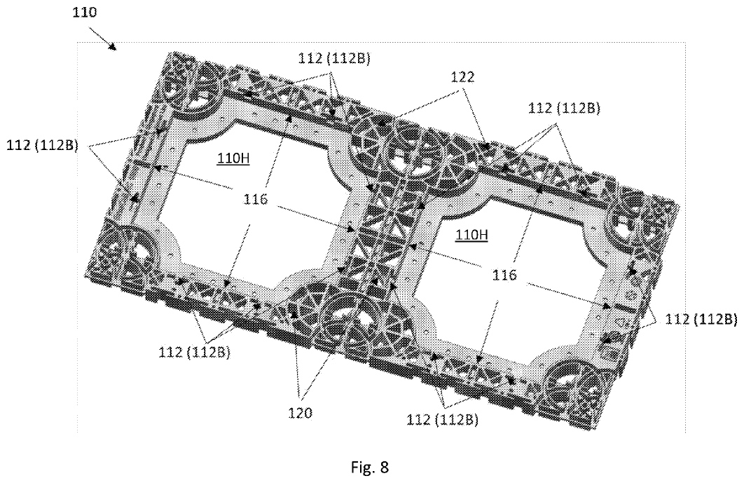

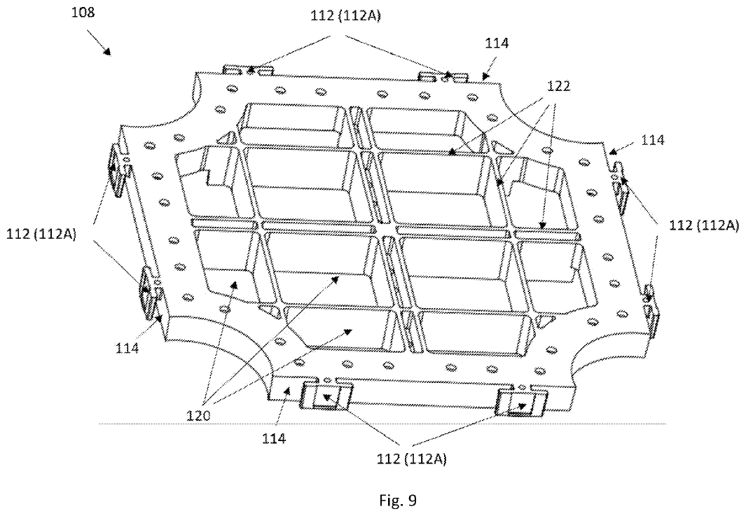

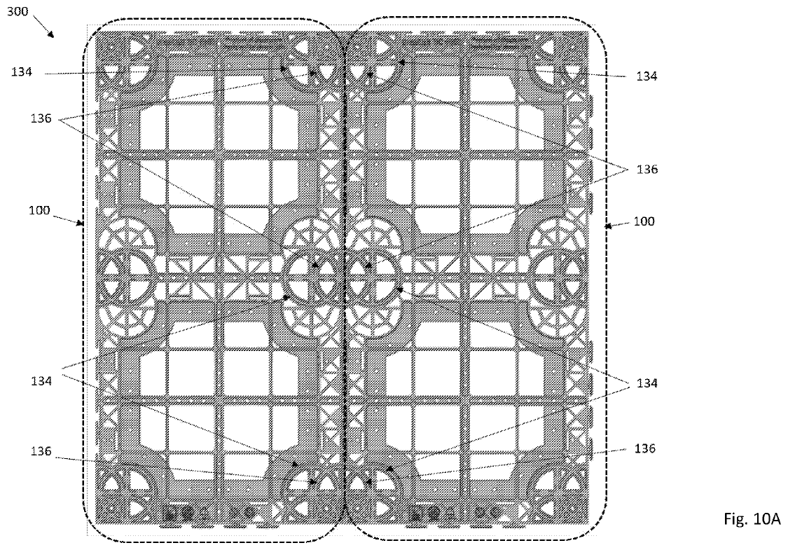

In another exemplary embodiment of the panel 100, the inner body section 108 may be detachable from the outer body section 110 (see FIG. 7 to FIG. 9). Hence, the panel 100 of this embodiment may be used with or without inner body section 108 attached to outer body section 110. To produce this panel 100, two separate moulds are required for making the inner section 108 and the outer body section 110 separately. A panel 100 without the inner body section 108 (i.e. the outer body section 110 as shown in FIG. 7 and FIG. 8) may be useful for applications where openings 110H (through holes) are required, such as tree root protection system, so that planting media and/or tree roots can pass through the panel 100 more easily through the openings 110H. Furthermore, such panel 100 may reduce the product cost as less material is required for making the panel 100. Inner body section 108 may be of any planar structures in any suitable shape and size. For example, the inner body section 108 may include two octagonal shaped planar structures as shown in FIG. 9. Inner body section 108 may be attachable to the outer body section 110 by locking members 112 (see FIG. 9) formed along outer sides 114 of the inner body section 108 and the corresponding inner sides 116 of outer body section 110. Locking members 112 may include a slot-type locking mechanism which includes male locking parts 112A extending from the inner body section 108 and female locking parts 112B disposed on the outer body section 110 or vice versa. Hence, the inner body section 108 may be detachably attached to outer body section 110 by engaging the male locking parts 112A to the female locking parts 112B. Other suitable types of locking mechanism or locking parts may also be used so long that they allow the inner body section 108 and the outer body section 110 to be attached firmly and securely to each other, and to be detached from each other easily and conveniently.

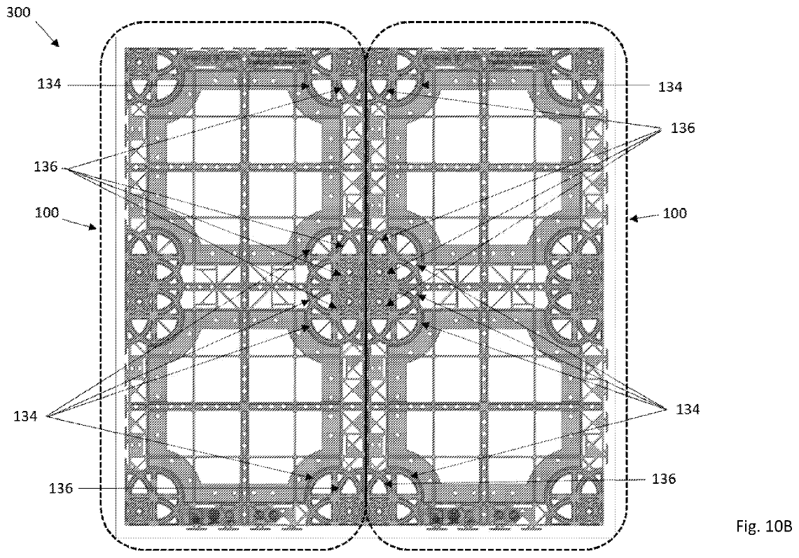

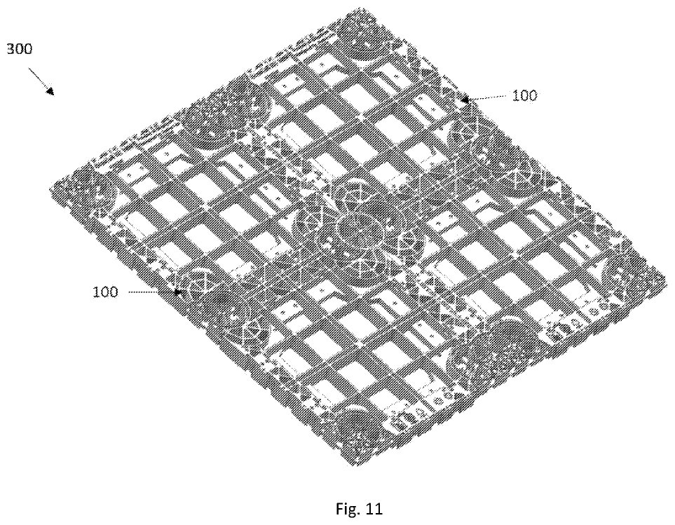

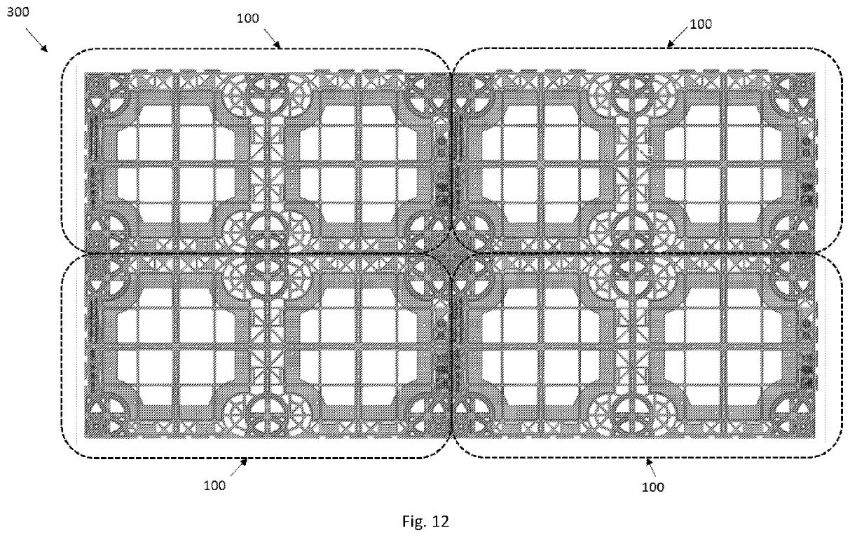

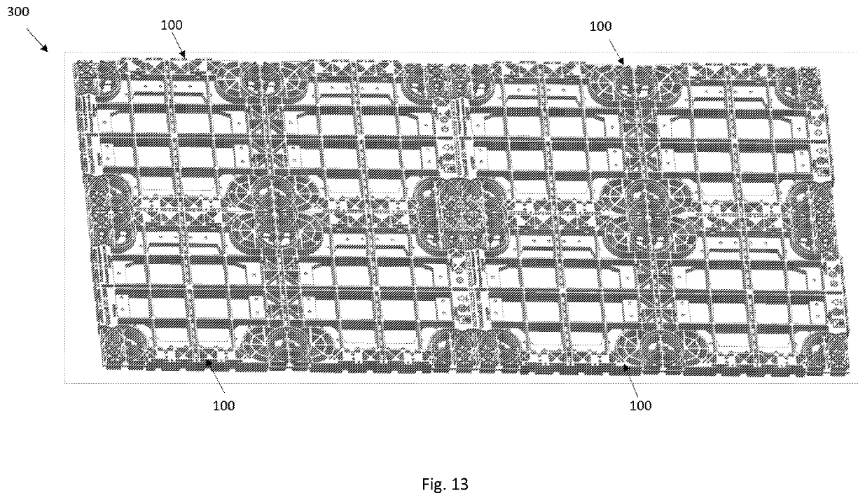

Referring to FIG. 1, the panel 100 has a plurality of interlocking members 118 formed along the boundary wall 106 for interlocking with corresponding interlocking members 118 of another panel 100, thereby allowing two or more panels 100 to interlock to each other laterally to form a layer of two or more panels 100. For example, FIGS. 10A & FIG. 10B show a layer of panels 300 formed by two interlocked panels 100 of different connecting portions 124, and FIG. 12 shows a layer of panels 300 formed by four interlocked panels 100. Interlocking members 118 (not shown in FIG. 10A or FIG. 10B) may include a slot-type locking mechanism 118 having male locking parts 118A and the corresponding female locking parts 118B. Hence, any number of panels 100 can be interlocked together and disengaged by hands (or tool) easily without damaging the panels 100. The used panels 100 can also be reusable for a new installation as panel 100 is strong, durable and able to last for many years. Other suitable types of interlocking members 118 may also be used so long that they allow two or more panels 100 to be laterally connected firmly and securely to each other, and to be disconnected conveniently. Interlocking members 118 may be detachable from the panel 100. Panels 100 may be held together by the detachable interlocking members 118.

Panel 100 may include a plurality of through holes 120 formed on the inner body section 108 and may be on the outer body section 110 allowing planting media (e.g. soil) and/or water to pass there through. Through holes 120 can be in any shape and size defined by a framework of interconnecting parts 122 extending from the top surface 102 to the bottom surface 104. Interconnecting parts 122 also act as reinforcing ribs to provide structural strength and rigidity of panel 100. For example, through holes 120 of square and rectangular shapes can be found in the inner body section 108, and the through holes 120 of triangular and rectangular shapes can be found in the outer body section 110. As can be seen in FIG. 10A, the through holes 120 in the inner body section 108 are larger than the through holes 120 in the outer body section 110, thereby allowing planting media and/or water to pass through the panel 100 more easily. The smaller through holes 120 (i.e. denser configuration) of interconnecting parts 122 of the outer body section 110 also enhances the rigidity of panel 100, thereby increasing the loading compacity (compressive strength) of the panel 100.

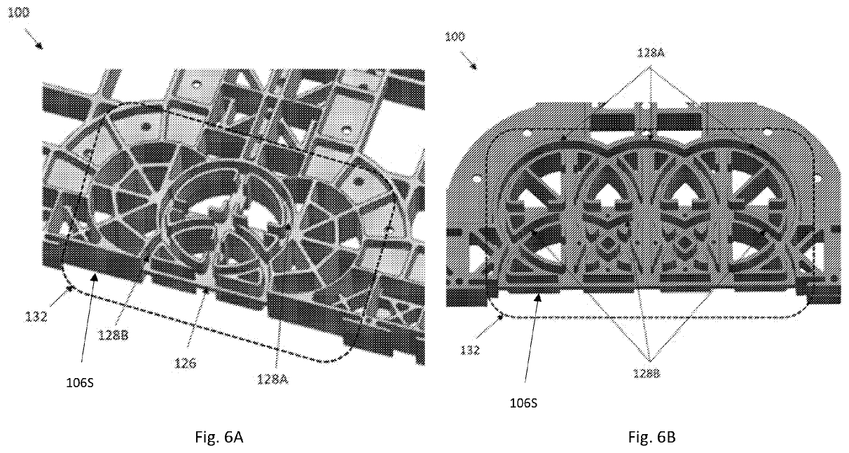

Referring to FIG. 1, the panel 100 has at least one connecting portion 124 formed on the top surface 102 and the bottom surface 104 within the outer body section 110. The at least one connecting portion 124 may include a plurality of grooves adapted to receive the connecting end 404A therein to connect the support column 400 to the panel 100. Plurality of grooves are narrow slots extending inwardly from the top surface 102 and the bottom surface 104 and configured to form a groove design or pattern on the top surface 102 and the bottom surface 104 for connection with suitable support columns 400 or legs. Top surface 102 and the bottom surface 104 may have identical layout of the connecting portions 124 facing in opposite directions separated by a thin base 126 (e.g. few millimetres thick) in-between (see FIG. 5 & FIG. 6). The depth of the grooves should be sufficient for receiving the support columns 400 therein in a tight-fit manner. First alignment pattern 128A may include a circular groove and the second alignment pattern 128B may include a semi-circular groove. Third alignment pattern 128C may include a quarter-circular groove.

FIG. 5 shows a partial enlarged view of the connecting portion 124 around a corner 130 of panel 100 where the first alignment pattern 128A, the second alignment pattern 128B, and the third alignment pattern 128C intersect with one another.

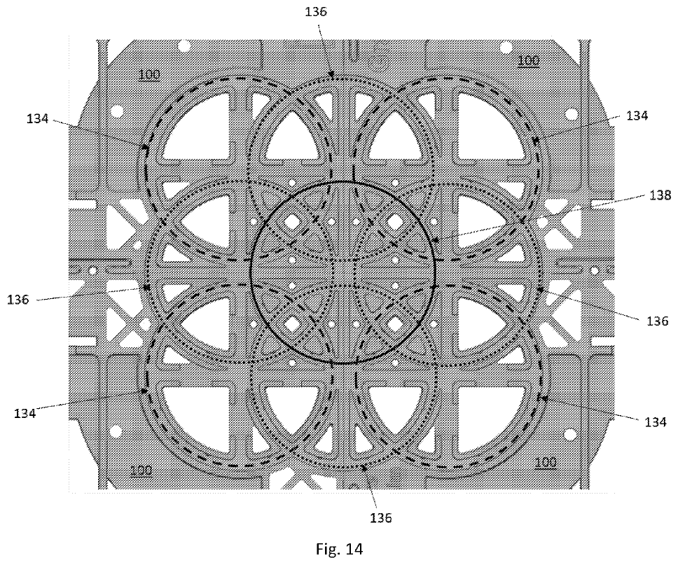

FIG. 6A shows a partial enlarged view of the connecting portion 124 along a length side 106A of the panel 100. Connecting portion 124 may be at a middle section 132 between the corners 130 along the length side 106A of the panel 100 where the first alignment pattern 128A and the second alignment pattern 128B intersect each other. FIG. 6B shows a partial enlarge view of another embodiment of the connecting portion 124 along a length side 106A of the panel 100. Connecting portion 124 may be at the middle section 132 of panel 100. As shown in FIG. 6B, the panel 100 may further include an another first alignment pattern 128A intersecting at a left side of the first alignment pattern 128A and another first alignment pattern 128A intersecting at a right side of the first alignment pattern 128A, an another second alignment pattern 128B intersecting a left side of the second alignment pattern 128B and an another second alignment pattern 128B intersecting a right side of the second alignment pattern 128B, such that the first alignment pattern 128A and both another first alignment patterns 128A and the second alignment pattern 128B and the another second alignment patterns 128B are lined along the length side 106A of the boundary wall 106. In other words, there may be three first alignment pattern 128A and three second alignment pattern 128B intersect one another and lined along a length side 106A of the boundary wall 106. As compared to FIG. 6A, this design provides more connection options with the support columns 400 and hence can further reduce the installation time and material cost. Due to the unique design of the connecting portion 124 as shown in interconnected panels 300 in FIG. 10A and FIG. 10B, the first alignment pattern 128A may be formed by a first alignment pattern 128A of an individual panel 100 (e.g. circular groove 134 as shown in FIG. 10A, FIG. 10B and FIG. 14), or formed by two second alignments pattern 128B of two interlocked panels 100 (e.g. circular groove 136 as shown in FIGS. 10A, 10B & 14), or formed by four third alignments pattern 128C of four interlocked panels 100 (e.g. circular groove 138 as shown in FIG. 14). Therefore, depending on the project requirements and budget, user may choose to connect a support column 400 to a connecting portion formed by first alignment pattern 128A, or to a circular groove formed by two second alignment patterns 128B, or to a circular groove formed by four third alignment patterns 128C. This inventive feature provides multiple connection options with the support columns 400 as one support column 400 can be shared by two interlocked panels 100 or four interlocked panels 100, thereby allowing a reduction in the number of support columns 400 for forming a multilayer panel structure 500. As a result, the material cost and installation cost of a multilayer panel structure 500 may be reduced significantly, especially for a large multilayer panel structure 500. For example, with reference to FIG. 10A and FIG. 10B, two interlocked panels 100 may be connected with less than the maximum number of support columns 400. Referring to FIG. 10A, nine support columns 400 may be used instead of twelve support columns 400, where three support columns 400 support two panels 100 (i.e. three sets of circular groove 136). Referring to FIG. 10B, nine support columns 400 may be used instead of sixteen support columns 400.

Referring to FIG. 15, a multilayer panel structure 500 is provided for promoting tree root growth, managing stormwater runoff, or supporting hardscape/softscape area, the multilayer panel structure 500 includes two or more layers of the panels 100 according to any one of the above various embodiments, such that each layer of the panels 100 may include two or more panels 100 interlocked together laterally via the interlocking members 118, and a plurality of support columns 400 connecting the two adjacent layers of the panels 100 space apart from each other such that each of the support columns 400 includes two connecting ends 404A, 404B opposite each other (see FIG. 16), each connecting end 404A, 404B connectable to each of the two adjacent layers of panels 100. Multilayer panel structure 500 may be formed by two or more layers of interlocked panels 100 connected vertically by support columns 400 (see FIG. 15). For example, FIG. 15 shows a multilayer panel structure 500 formed by three layers of panels 300. Depending on the application, a large multilayer panel structure 500 of few hundred or thousand square meters can be constructed. Void space 410 is created between two layers of panels 100 separated by support columns 400. Panels 100 with through holes 120 allow void space 410 to be filled with soil (or other planting media) but prevent the soil from being compacted by vertical loads. This creates a protected growth zone within void space 410 with uncompacted soil and filled with sufficient oxygen and moisture for promoting healthy tree root growth. So, multilayer panel structure 500 may be used as a tree root protection system by installing the structure around the root ball of a big tree so that the roots may grow and extend freely into the protected growth zone that filled with oxygen and moisture to nurture the tree roots. Furthermore, a protected grown zone with lesser support columns 400 inside the zone can be created due to the unique groove design of panels 100 for sharing of support columns 400. Consequently, tree roots may grow and extend more freely within the protected growth zone with less resistance.

Multilayer panel structure 500 may also be installed under a hardscape/softscape to form a strong and stable underground base for supporting the hardscape/softscape above due to the high compressive strength of the multilayer panel structure 500 which can sustain an extreme high vertical load such as fire engine/truck of 30 tonnes or more. Hence, the multilayer panel structure 500 can help to prevent damages to hardscape/softscape due to poor soil structure. Furthermore, the multilayer panel structure 500 may further include a waterproofing sheet adapted be lined outside the structure 500 to retain water within the structure 500. Multilayer panel structure 500 may also be used to form a water retention or detention system to control and manage stormwater runoff in the urban or flood-prone areas. To form a water retention/detention system, the base and all vertical sides (covered by panels 100) of the structure 500 are wrapped by a layer of waterproofing sheet to retain stormwater within the structure 500. The sides of the multilayer panel structure 500 are covered by the panels 100 such that the waterproofing sheet wraps around the structure 500 over the top edge of the structure 500 and the top surface of the structure 500 is covered by a layer of geotextile for filtering and preventing soil/sand from entering the structure 500. In this way, water can be retained within the structure 500. The system will also be connected with an inlet with filtration to collect stormwater and remove trash or big particles, an outlet to discharge the collected water to public drains in a slower rate (as water detention tank), and/or an overflow outlet to discharge the excess water from the system (as water retention tank) which can be used for irrigation. Hence, this system provides a cheap and efficient way (made of recycled plastics, no curing time, easy to assemble, less labour time) to manage stormwater runoff to prevent flooding or for other purposes.

Multilayer panel structure 500 may be constructed in any height without restrictions as support columns 400 can be formed in any length as required. FIG. 16 shows a perspective view of support column 400. Support column 400 may include a hollow tubular body 402 with two connecting ends 404A, 404B at opposing ends of the support column 400. A layer of two or more interlocked panels 100 with a plurality of short support columns 400 (or other suitable legs) connected to the connecting portions 124 on the bottom surface 104 of the two or more interlocked panels 100 forms a pallet.

Support column 400 may include a space therein and is adapted to be filled with mortar to enhance the compressive strength of the multilayer panel structure 500. Support column 400 may include a plurality of intersecting parts 406 connected to the internal wall of hollow tubular body 402 and extending along an axial direction of the hollow tubular body 402 from one connecting end 404A to another connecting end 404B. Hollow tubular body 402 may therefore be divided into several compartments 408 in a circumferential direction by intersecting parts 406 to reinforce the strength and rigidity of support column 400. For example, a support column 400 with two intersecting parts 406 and four compartments is shown in FIG. 16. If necessary, during installation, support column 400 may be filled with cement grout to further increase the strength of support column 400. Support column 400 may be made from 100% recycled plastic materials (e.g. polypropylene or polyvinyl chloride (PVC)). Referring to FIG. 15, a two-layer multilayer panel structure 500 with support columns 400 made from polypropylene can achieve a compressive strength of at least 60 tonnes/m². Alternatively, a two-layer multilayer panel structure 500 with support columns 400 made from PVC can achieve a higher compressive strength of at least 100 tonnes/m². Support column 400 may have a diameter that allows connecting ends 404A, 404B to be connected to the first alignment pattern 128A, or two second alignment pattern 128B, or four third alignment pattern 128C.

While this invention has been described in certain aspects and with reference to specific embodiments. It should be understood by those skilled in the art that various modifications and/or variations may be made to the invention without departing from the scope of the invention as broadly described and as set forth in the following claims and the features described in one example may not be restricted to that example and may be combined with any one of the other examples. Thus, the embodiments should be considered in all respects as illustrative and not restrictive.

The present invention relates to a panel 100 and a multilayer panel structure 500 generally as herein described, with reference to and/or illustrated in the accompanying drawings.

1. A panel comprising:
a main body comprising,
a top surface, a bottom surface opposite the top surface, wherein the top surface comprises a top perimeter edge and the bottom surface comprises a bottom perimeter edge,
a boundary wall extending from the top perimeter edge to the bottom perimeter edge,
a plurality of interlocking members formed along the boundary wall adapted to engage the corresponding plurality of interlocking members of another panel,
at least one connecting portion disposed adjacent the boundary wall and on the top surface and adapted to connect a support column for supporting the main body and the support column comprises a connecting end connectable to the main body, wherein the at least one connecting portion is configured to comprise,
a first alignment pattern adapted to align the connecting end to connect to the at least one connecting portion within the boundary wall when connected, and
a second alignment pattern adapted to align the connecting end to connect a portion of the connecting end to the at least one connecting portion, wherein the connecting end protrudes out of the boundary wall when connected, wherein the first alignment pattern intersects with the second alignment pattern, wherein the first alignment pattern comprises a circular groove and the second alignment pattern comprises a semi-circular groove, wherein each of the at least one connecting portion comprises a plurality of through holes between the first alignment pattern and the second alignment pattern and wherein the second alignment pattern of the panel when aligned to the second alignment pattern of the another panel, forms the first alignment pattern to align the connecting end to connect to the panel and the another panel.

2. The panel according to claim 1, wherein the boundary wall comprises a pair of length sides spaced apart from each other and a pair of width sides extended between and across the pair of length sides, wherein the pair of length sides coincides with the pair of width sides to form four corners, each corner formed by a length side and a width side, wherein the main body comprises a plurality of connecting portions on the top surface, wherein each of the four corners comprises a connecting portion.

3. The panel according to claim 2, wherein the connecting portion at each of the corners further comprises a third alignment pattern adapted to align the connecting end to connect a portion of the connecting end to the connecting portion, wherein the connecting end protrudes out of the length side and the width side of one of the corners when connected, wherein the third alignment pattern intersects with the first alignment pattern and the second alignment pattern, and wherein the third alignment pattern of the panel when aligned to the third alignment patterns of three of the another panels abutting each other at the respective corners form the first alignment pattern to align the connecting end to connect to the panel and the three of the another panels.

4. The panel according to claim 2, wherein the main body further comprises a connecting portion disposed adjacent each of the length sides of the boundary wall, between the corners along each length side, and on the top surface.

5. The panel according to claim 1, further comprising another connecting portion disposed adjacent the boundary wall and on the bottom surface of the main body.

6. The panel according to claim 2, further comprising a plurality of connecting portions disposed at each of the corners and on the bottom surface of the main body.

7. The panel according to claim 5, further comprising the another connecting portion disposed adjacent each of the length sides of the boundary wall, between the corners along each of the length sides, and on the bottom surface.

8. The panel according to claim 7, further comprising an another first alignment pattern intersecting at a left side of the first alignment pattern and another first alignment pattern intersecting at a right side of the first alignment pattern, an another second alignment pattern intersecting a left side of the second alignment pattern and an another second alignment pattern intersecting a right side of the second alignment pattern, wherein the first alignment pattern and both another first alignment patterns and the second alignment pattern and the another second alignment patterns are lined along the length side of the boundary wall.

9. The panel according to claim 1, wherein the connecting portion or another connecting portion comprises a plurality of grooves adapted to receive the connecting end therein to connect the support column to the panel, wherein the first alignment pattern comprises a circular groove and the second alignment pattern comprises a semi-circular groove.

10. The panel according to claim 9, wherein the third alignment pattern comprises a quarter-circular groove.

11. The panel according to claim 1, wherein the main body comprises an outer body section along the boundary wall and an inner body section within the outer body section, wherein the inner body section is detachable from the outer body section.

12. A multilayer panel structure for promoting tree root growth, managing stormwater runoff, or supporting hardscape/softscape area, the multilayer panel structure comprising:
two or more layers of the panels according to claim 1, wherein each layer of the panels comprises two or more panels interlocked together laterally via the interlocking members, and
a plurality of support columns connecting the two adjacent layers of the panels space apart from each other wherein each of the support columns comprises two connecting ends opposite each other, each connecting end connectable to each of the two adjacent layers of panels.

13. The panel structure according to claim 12, wherein each of the connecting ends of the support column is connectable to the connecting portion and aligned to one of the first alignment pattern on a panel, the second alignment patterns formed by two adjacent panels and the third alignment patterns formed by four adjacent panels, wherein a support column is configured to support one, two or four panels respectively.

14. The multilayer panel structure according to claim 12, further comprising a waterproofing sheet adapted be lined outside the structure to retain water within the structure.

15. The multilayer panel structure according to claim 12 wherein the support column comprises a space therein and is adapted to be filled with mortar to enhance the compressive strength of the multilayer panel structure.
